(19) United States
(12) Patent Application Publication
(10) Pub. No.: US 2014/0158936 A1
(43) Pub. Date: Jun. 12, 2014

(54) PHOTONIC CRYSTAL PHOSPHOR

(71) Applicant: SAMSUNG DISPLAY CO., LTD., Yongin-City (KR)

(72) Inventors: Chi-O CHO, Asan-si (KR); Myeong-Ju SHIN, Seoul (KR); Dong-Yeon KANG, Geochang-gun (KR); Dong-Hwan KIM, Seoul (KR); Ju-Young YOON, Seoul (KR); Young-Chun KIM, Seoul (KR); Jung-Kyun KIM, Seoul (KR)

(73) Assignee: Samsung Display Co., LTD., Yongin-City (KR)

(21) Appl. No.: 13/849,002

(22) Filed: Mar. 22, 2013

(30) Foreign Application Priority Data
Dec. 10, 2012 (KR) 10-2012-0142493

(51) Int. Cl. C09K 11/02

(52) U.S. Cl. CPC C09K 11/025
USPC 252/301.6 R; 252/301.4 R; 252/301.4 F

(57) ABSTRACT

A photonic crystal phosphor includes a phosphor which absorbs light and emits excited light having a radiation spectrum, a first coating layer covering the phosphor and having a first thickness, and a second coating layer covering the phosphor and having a second thickness. The first coating layer has a first refractive index. The second coating layer has a second refractive index. The first coating layer is between the phosphor and the second coating layer.

This application claims priority to Korean Patent Application No. 10-2012-0142493, filed on Dec. 10, 2012, and all the benefits accruing therefrom under 35 U.S.C. §119, the contents of which in its entirety is herein incorporated by reference.

### BACKGROUND

1. Field

Exemplary embodiments of the invention relate to a photonic crystal phosphor. More particularly, exemplary embodiments of the invention relate to a photonic crystal phosphor for a display device.

2. Description of the Related Art

Generally, a display device includes a display panel displaying an image and a backlight unit supplying light to the display panel. The display panel adjusts luminance of the light from the backlight unit to display an image. The backlight unit includes a light source emitting the light. Light emitting diodes (“LEDs”) are used as the light source of the backlight unit. For example, the LEDs may emit red light, green light or blue light.

### SUMMARY

One or more exemplary embodiment of the invention provides a photonic crystal phosphor for implementing color light having a desired chromaticity in a color space.

In an exemplary embodiment of a photonic crystal phosphor according to the invention, the photonic crystal phosphor includes a phosphor which absorbs light and emits excited light having a radiation spectrum, a first coating layer covering the phosphor and having a first thickness, and a second coating layer covering the phosphor and having a second thickness. The first coating layer has a first refractive index. The second coating layer has a second refractive index. The first coating layer is between the phosphor and the second coating layer.

In an exemplary embodiment, the first thickness may be different from the second thickness.

In an exemplary embodiment, the first thickness may be determined by a maximum emission wavelength, a full width at half maximum of the radiation spectrum and the first refractive index.

In an exemplary embodiment, the first thickness may be substantially between (L−W_{H})/(4×n₁) and (L+W_{H})/(4×n₁) nanometers, where L represents the maximum emission wavelength, W_{H} represents the full width at half maximum and n₁ represents the first refractive index.

In an exemplary embodiment, the second thickness may be determined by a maximum emission wavelength, a full width at half maximum of the radiation spectrum and the second refractive index.

In an exemplary embodiment, the second thickness may be substantially between (L−W_{H})/(4×n₂) and (L+W_{H})/(4×n₂) nanometers, where L represents the maximum emission wavelength, W_{H} represents the full width at half maximum and n₂ represents the second refractive index.

In an exemplary embodiment, the first thickness and the second thickness may be determined by a maximum emission wavelength, a full width at half maximum of the radiation spectrum, the first refractive index and the second refractive index.

In an exemplary embodiment, the first thickness may be substantially between [L−100×|n₁−n₂|−W_{H}]/(4×n₁) and [L−100×|n₁−n₂|+W_{H}]/(4×n₁) nanometers, where L represents the maximum emission wavelength, W_{H} represents the full width at half maximum, n₁ represents the first refractive index and n₂ represents the second refractive index.

In an exemplary embodiment, the second thickness may be substantially between [L−100×|n₁−n₂|−W_{H}]/(4×n₂) and [L−100×|n₁−n₂|+W_{H}]/(4×n₂) nanometers, where L represents the maximum emission wavelength, W_{H} represents the full width at half maximum, n₁ represents the first refractive index and n₂ represents the second refractive index.

In an exemplary embodiment, the first thickness may be substantially between [L+100×|n₁−n₂|−W_{H}]/(4×n₁) and [L+100×|n₁−n₂|+W_{H}]/(4×n₁) nanometers, where L represents the maximum emission wavelength, W_{H} represents the full width at half maximum, n₁ represents the first refractive index and n₂ represents the second refractive index.

In an exemplary embodiment, the second thickness may be substantially between [L+100×|n₁−n₂|−W_{H}]/(4×n₂) and [L+100×|n₁−n₂|+W_{H}]/(4×n₂) nanometers, where L represents the maximum emission wavelength, W_{H} represents the full width at half maximum, n₁ represents the first refractive index and n₂ represents the second refractive index.

In an exemplary embodiment, a covering layer of the photonic crystal phosphor may include the first coating layer and the second coating layer. The photonic crystal phosphor may further include a plurality of covering layers which sequentially covers the phosphor.

In an exemplary embodiment, a number of the covering layers which covers the phosphor may be equal to or more than 3 and equal to or less than 5.

In an exemplary embodiment, a first covering layer of the photonic crystal phosphor may include the first coating layer and the second coating layer. The photonic crystal phosphor may include a second covering layer. The second covering layer may include a third coating layer covering the first covering layer and having a third thickness, and a fourth coating layer covering the third coating layer and having a fourth thickness. The third coating layer may have a third refractive index. The fourth coating layer may have a fourth refractive index. The first covering layer may be between the phosphor and the second covering layer.

In an exemplary embodiment, the first and the second thicknesses may be different from the third and the fourth thicknesses, respectively.

In an exemplary embodiment, the radiation spectrum may have a maximum emission wavelength substantially between about 530 and about 550 nanometers.

In an exemplary embodiment, the radiation spectrum may have a maximum emission wavelength substantially between about 610 and about 670 nanometers.

In an exemplary embodiment, the first and the second refractive indices may be substantially between about 1.6 and about 2.5, respectively.

In an exemplary embodiment, the first coating layer and the second coating layer may include at least one of silicon oxide, titanium oxide, aluminum oxide, yttrium oxide, hafnium oxide, zinc oxide, zirconium oxide, magnesium oxide, gallium oxide, aluminum nitride and silicon carbide.

According to one or more exemplary embodiment of a photonic crystal phosphor, a phosphor emitting excited light having a desired radiation spectrum may be covered by a plurality of coating layers having different refractive indices with proper thicknesses to improve chromaticity of color light emitted toward outside.

### BRIEF DESCRIPTION OF THE DRAWINGS

The above and other features and advantages of the invention will become more apparent by describing in detailed exemplary embodiments thereof with reference to the accompanying drawings, in which:

FIG. 1 is a cross-sectional view of an exemplary embodiment of a photonic crystal phosphor according to the invention;

FIG. 2 is an enlarged cross-sectional view illustrating portion A of FIG. 1;

FIG. 3A is a graph illustrating emission efficiency of excited light (E(λ)) from the phosphor of FIG. 1 according to wavelength (λ) in nanometers (nm);

FIG. 3B is a graph illustrating emission efficiency (E(λ)) of the photonic crystal phosphor and reflection efficiency (R(λ)) of the coating layers of FIG. 1 according to wavelength (λ) in nanometers (nm);

FIG. 4 is a cross-sectional view illustrating another exemplary embodiment of a photonic crystal phosphor according to the invention; and

FIG. 5 is a cross-sectional view illustrating still another exemplary embodiment of a photonic crystal phosphor according to the invention.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When a display panel of a display device includes a liquid crystal layer therein, transmission of the light from a backlight unit of the display device is controlled by the liquid crystal layer. However, if conventional light emitting diodes (“LEDs”) are used as the light source of the backlight unit in a liquid crystal display (“LCD”) device, then red, green and blue (“RGB”) colors are not sufficiently implemented in the LCD device.

More particularly, if colors corresponding to color coordinates in a color space such as ADOBE® RGB color space are fully represented as color images in a display device, then the display device is considered to have high color reproducibility. That is, light emitted from a light source of the display device has a radiation spectrum according to wavelengths of light. If the radiation spectrum is distributed within a waveband of a color corresponding to a certain color coordinate in the color space, then the display device is considered to represent that certain color.

However, the LCD device using conventional LEDs as light sources does not represent a pure color having high chromaticity in the color space. For example, a color spectrum of a conventional green LED is distributed over a wide waveband including green light wavelengths so that light from the conventional green LED is not sufficient to represent a pure green color having high chromaticity in the color space, such as the ADOBE® RGB color space. Therefore, there remains a need for a light source which emits light with improved chromaticity.

Hereinafter, exemplary embodiments of the invention will be described in further detail with reference to the accompanying drawings.

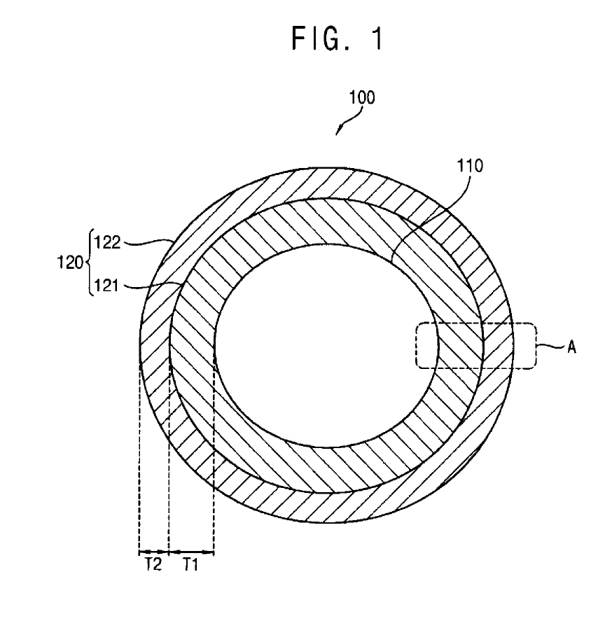

FIG. 1 is a cross-sectional view of an exemplary embodiment of a photonic crystal phosphor according to the invention. The photonic crystal phosphor according to the invention may be included in a light source, such as for a display device, but is not limited thereto or thereby.

Referring to FIG. 1, an exemplary embodiment of a photonic crystal phosphor 100 according to the invention includes a phosphor 110 disposed substantially at a center of the photonic crystal phosphor 100, and a first covering layer 120 which covers an outer surface of the phosphor 110. The first covering layer 120 includes a first coating layer 121 covering the phosphor 110 and a second coating layer 122 covering the first coating layer 121.

From a ground state, the phosphor 110 absorbs light having a desired wavelength and is excited by the absorbed light. After the phosphor 110 is excited, the excited phosphor 110 radiates light energy and returns to the ground state. The light energy radiated from the phosphor 110 has a radiation spectrum having a different emissivity according to wavelength. In one exemplary embodiment, for example, the phosphor 110 may radiate red light, green light or blue light according to maximum emission wavelengths of the radiation spectrum. When the phosphor 110 radiates the green light, the phosphor 110 may include materials such as a phase of the formula Si6-zLzOzN8-z where L is a Group 13 element such as Al (e.g., β-SiAlON), (Ba, Sr)2SiO4:Eu or CaSc20:Ce. The green light may have a maximum emission wavelength substantially between about 530 nanometers and about 550 nanometers. Alternatively, when the phosphor 110 radiates the red light, the phosphor 110 may include materials such as CaAlSiN3:Eu, (Sr, Ca)AlSiN3:Eu, or CaAlSi(ON)3:Eu. The red light may have a maximum emission wavelength substantially between about 610 nanometers and about 670 nanometers.

The first coating layer 121 has a first refractive index n₁. The first coating layer 121 covers the outer surface of the phosphor 110 with a first thickness T1 determined by the radiation spectrum. The first thickness T1 may be taken in a direction normal to the phosphor 110. In one exemplary embodiment, for example, the first thickness T1 may be determined by the maximum emission wavelength, a full width at half maximum (hereinafter, “FWHM”) of the radiation spectrum and the first refractive index n₁.

The second coating layer 122 has a second refractive index n₂. The second coating layer 122 covers the first coating layer 121 with a second thickness T2 determined by the radiation spectrum. In one exemplary embodiment, for example, the second thickness T2 may be determined by the maximum emission wavelength, the FWHM of the radiation spectrum and the second refractive index n₂.

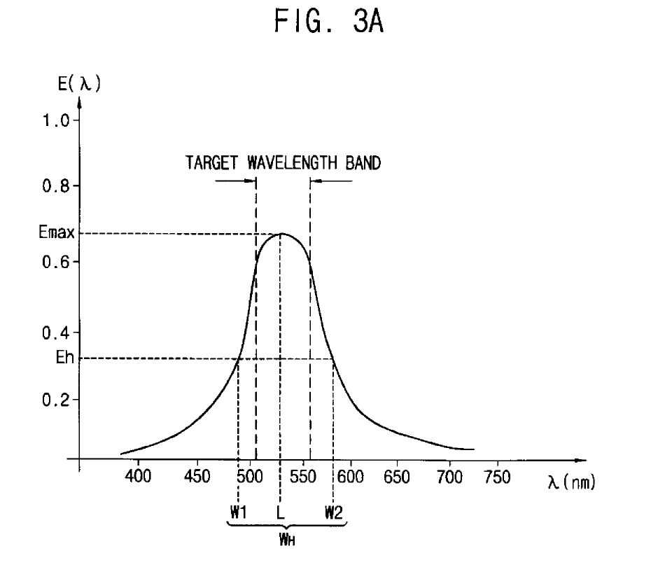

Alternatively, the first thickness T1 of the first coating layer 121 and the second thickness T2 of the second coating layer 122 may be determined by the maximum emission wavelength, the FWHM of the radiation spectrum, the first refractive index n₁ and the second refractive index n₂. The first thickness T1 may be substantially different from the second thickness T2. The first and second thicknesses T1 and T2 are described in more detail referring to FIG. 3B.

The first coating layer 121 and the second coating layer 122 may include at least one of silicon oxide, titanium oxide, yttrium oxide, hafnium oxide, zinc oxide, zirconium oxide, magnesium oxide, gallium nitride, aluminum nitride and silicon carbide. In one exemplary embodiment, for example, the first coating layer 121 and the second coating layer 122 may include one of Al2O3, Y2O3, TiO2, BaTiO3, HfO2, ZnO, ZrO2, MgO, MN and GaN. The first refractive index n₁ of the first coating layer 121 and the second refractive index n₂ of the second coating layer 122 may be substantially between about 1.6 and about 2.5.

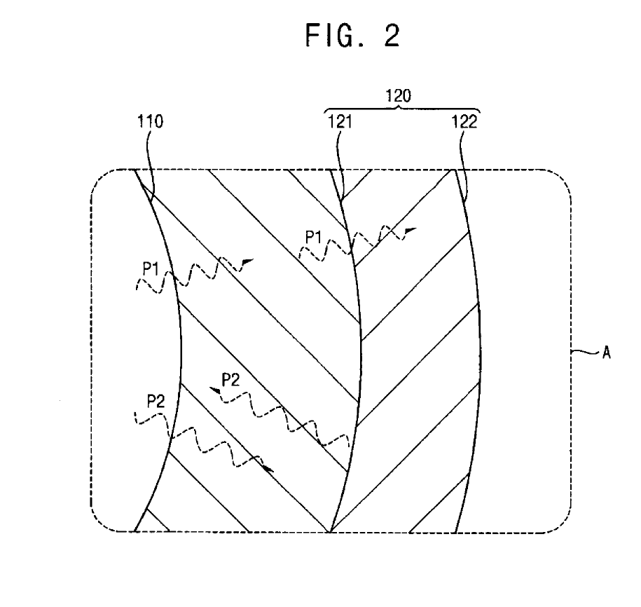

FIG. 2 is an enlarged cross-sectional view illustrating portion A of FIG. 1.

Referring to FIG. 2, excited light radiated from the phosphor 110 includes a plurality of lights having desired wavelengths. In the illustrated exemplary embodiment, for example, the excited light may include a first light P1 having a first wavelength adjacent to (e.g., close to) the maximum emission wavelength. Also, the excited light may further include a second light P2 having a second wavelength which is longer than the first wavelength and less adjacent to (e.g., further away from) the maximum emission wavelength. Without the first coating layer 121 and the second coating layer 122, the excited light radiated from the phosphor 110 includes the first light P1 and the second light P2. Also, a color light represented by the phosphor 110 includes color lights of the first wavelength and the second wavelength.

However, when the first coating layer 121 and the second coating layer 122 cover the outer surface of the phosphor 110 as illustrated in FIG. 2, some light having a particular wavelength may be reflected inward due to the first and the second coating layers 121 and 122 while other light having another particular wavelength may be transmitted outward. In the illustrated exemplary embodiment, for example, the first light P1 having the first wavelength may be transmitted outward through the first and the second coating layers 121 and 122 while the second light P2 having the second wavelength may be reflected inward due to the first and the second coating layers 121 and 122. Where the first and second lights P1 and P2 are respectively transmitted and reflected as described above, the first light P1 and the second light P2 may be reflected and/or transmitted according to the thicknesses T1 and T2 of the first and the second coating layers 121 and 122. That is, the thicknesses T1 and T2 of the first and the second coating layers 121 and 122 may be determined to adjust an amount of light ultimately emitted from the photonic crystal phosphor 100 according to a radiation spectrum of which the excited light radiated from the phosphor 110 represents.

FIG. 3A is a graph illustrating emission efficiency of excited light from the phosphor of FIG. 1 according to wavelength. In FIG. 3A, a horizontal axis represents the wavelength (λ) in nanometers (nm) and a vertical axis represents emissivity (E(λ)).

Referring to FIG. 3A, a radiation spectrum of excited light from the phosphor 110 has a maximum emissivity Emax at a particular wavelength L. Although the maximum emission wavelength L is illustrated to be positioned between 500 nm and 550 nm which indicates a green waveband, the maximum emission wavelength L of the radiation spectrum may be positioned in a red waveband or a blue waveband according to the excited light of the phosphor 110.

A FWHM represents a width W_{H} between wavelengths W1 and W2 having 50% emissivity Eh of the maximum emissivity Emax. The maximum emission wavelength L is positioned between a short wavelength W1 and a long wavelength W2 defining a threshold of the FWHM.

Referring to FIG. 3A, a target wavelength band represents a waveband on which a radiation spectrum of light emitted from the photonic crystal phosphor 100 is to be concentrated. However, the excited light emitted from the phosphor 110 includes lights having wavelengths other than the target wavelength band. Accordingly, the lights having wavelengths other than the target wavelength band are required to be reduced or removed to implement a color corresponding to a desired color coordinate in a color space.

FIG. 3B is a graph illustrating emission efficiency of the photonic crystal phosphor and reflection efficiency of the coating layers of FIG. 1 according to wavelength. In FIG. 3B, a horizontal axis also represents wavelength λ in nm and a vertical axis represents emissivity (E(λ)) or reflectivity (R(λ)). In FIG. 3B, a solid line Ewc(λ) represents the emissivity of the photonic crystal phosphor 100 including the coating layers 121 and 122, a dotted line Ewoc(λ) represents the emissivity of the phosphor 110, and two dash-dot lines R(λ) represent reflectivities of the coating layers 121 and 122.

Referring to FIG. 3B, light emitted from the phosphor 110 includes lights having wavelengths other than the target wavelength band. However, when the phosphor 110 is covered by the first coating layer 121 and the second coating layer 122, a part of the light emitted from the phosphor 110 is reduced or removed according to reflection spectra of the first and the second coating layers 121 and 122. Emissivity of the photonic crystal phosphor 100 is increased in the target wavelength band including the maximum emission wavelength L due to the reflection spectra. Accordingly, the excited light from the phosphor 110 which is covered by the first and the second coating layers 121 and 122 has high emissivity within the target wavelength band and low emissivity outside the target wavelength band.

As mentioned above, a portion of the excited light having a desired radiation spectrum is reflected inward by coating layers 121 and 122 covering the phosphor 110 to adjust emissivity of light emitted from the photonic crystal phosphor 100 according to a wavelength of the light. Accordingly, a color light emitted by the photonic crystal phosphor, corresponding to a desired color coordinate in a color space may be implemented.

A reflection spectrum R(λ) may be determined by the thicknesses T1 and T2 of the first and the second coating layers 121 and 122. That is, the thicknesses T1 and T2 of the first and the second coating layers 121 and 122 may be properly adjusted to effectively reflect lights having wavelengths other than the target wavelength band. For proper adjustment the thicknesses T1 and T2 of the first and the second coating layers 121 and 122 may be determined by refractive indices of the coating layers 121 and 122, the maximum emission wavelength L, and the FWHM W_{H}.

In one exemplary embodiment, for example, the first thickness T1 of the first coating layer 121 and the second thickness T2 of the second coating layer 122 may be defined as following Equations 1 and 2,

(L−W_{H})/(4×n1)≦T1≦(L+W_{H})/(4×n1), and Equation 1

(L−W_{H})/(4×n2)≦T2≦(L+W_{H})/4×n2). Equation 2

where L represents a maximum emission wavelength of a phosphor, W_{H} represents a FWHM, n₁ represents a refractive index of a first coating layer and n₂ represents a refractive index of a second coating layer.

As the thicknesses T1 and T2 of the first and the second coating layers 121 and 122 are determined within the range of Equations 1 and 2, resonance may be occur at wavelengths within the FWHM of the radiation spectrum of the phosphor 110 to increase emissivity at the maximum emission wavelength L of the photonic crystal phosphor 100.

Alternatively, the first thickness T1 of the first coating layer 121 and the second thickness T2 of the second coating layer 122 may be defined as following Equations 3 and 4,

[L−100×|n1−n2−|−W_{H}]/(4×n1)≦T1≦[L−100×|n1−n2]+W_{H}]/(4×n1), and Equation 3

and

[L−100×|n1−n2|−W_{H}]/(4×n2)≦T2≦[L−100×n1−n2|+W_{H}]/(4×n2), Equation 2

where |n₁−n₂ represents absolute value of the difference between the refractive indices of the first and second coating layers 121 and 122.

As the thicknesses T1 and T2 of the first and the second coating layers 121 and 122 are determined within the range of Equations 3 and 4, lights having wavelengths longer than a long wavelength threshold W_{tH} of the target wavelength band may be reflected to effectively reduce or remove lights having wavelengths longer than the target wavelength band.

Also, the first thickness T1 of the first coating layer 121 and the second thickness T2 of the second coating layer 122 may be defined as following Equations 5 and 6,

[L+100×n1−n2|−W_{H}]/(4×n1)≦T1≦[L+100×|n1−n2|+W_{H}]/(4×n1), and Equation 5

[L+100×|n1−n2|−W_{H}]/(4×n2)≦T2≦[L+100×|n1−n2|+W_{H}]/(4×n2) Equation 6

As the thicknesses T1 and T2 of the first and the second coating layers 121 and 122 are determined within the range of Equations 5 and 6, lights having wavelengths shorter than a short wavelength threshold W_{tL} of the target wavelength band may be reflected to effectively reduce or remove lights having wavelengths shorter than the target wavelength band.

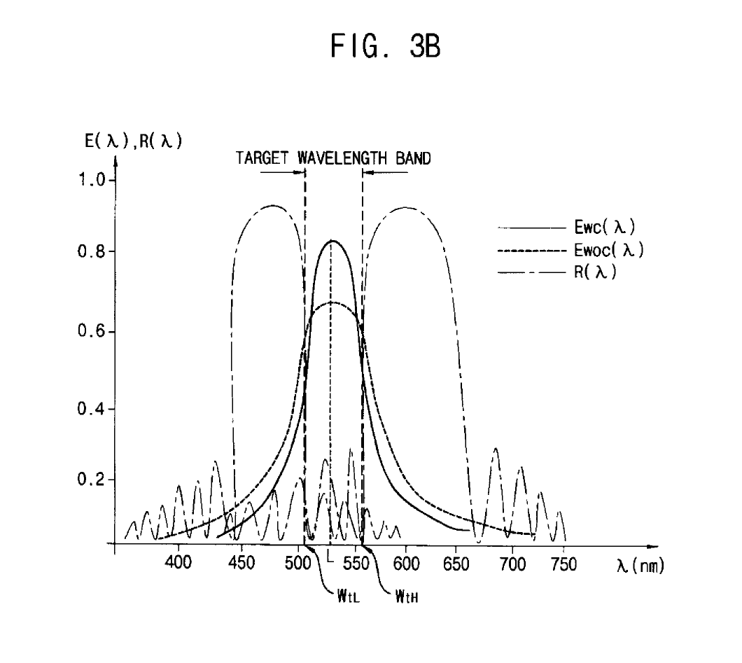

FIG. 4 is a cross-sectional view illustrating another exemplary embodiment of a photonic crystal phosphor according to the invention.

Referring to FIG. 4, a photonic crystal phosphor 200 includes a phosphor 210 disposed substantially at a center of the photonic crystal phosphor 200, and a first covering layer 220 which covers an outer surface of the phosphor 210. The first covering layer 220 includes a first coating layer 221 covering the phosphor 210 and a second coating layer 222 covering the first coating layer 221.

Also, the exemplary embodiment of the photonic crystal phosphor 200 includes the phosphor 210 covered by a plurality of covering layers 220, 230 and 240. That is, an outer surface of the first covering layer 220 is covered by a second covering layer 230 including a third coating layer 231 and a fourth coating layer 232. Likewise, an outer surface of the second covering layer 230 is covered by a third covering layer 240 including a fifth coating layer 241 and a sixth coating layer 242. Although the photonic crystal phosphor 200 includes three covering layers 220, 230 and 240 covering the phosphor 210 in FIG. 4, the number of the covering layers which cover the phosphor 210 may be various. In one exemplary embodiment, for example, the number of the covering layers may be equal to or more than 3 and equal to or less than 5, but is not limited thereto or thereby.

In the illustrated exemplary embodiment, first and second thicknesses T1 and T2 and first and second refractive indices n1 and n2 of the first covering layer 220, the second covering layer 230 and the third covering layer 240 may be substantially the same as each other.

That is, thicknesses of the first coating layer 221, the third coating layer 231 and the fifth coating layer 241 may be substantially equal to T1. Refractive indices of the first coating layer 221, the third coating layer 231 and the fifth coating layer 241 may be substantially equal to n₁. Also, the first, the third and the fifth coating layers 221, 231 and 241 may include a single or same material.

Likewise, thicknesses of the second coating layer 222, the fourth coating layer 232 and the sixth coating layer 242 may be substantially equal to T2. Refractive indices of the second coating layer 222, the fourth coating layer 232 and the sixth coating layer 242 may be substantially equal to n₂. Also, the second, the fourth and the sixth coating layers 222, 232 and 242 may include a single or same material.

As mentioned above, the exemplary embodiment of the photonic crystal phosphor 200 according to the invention includes a phosphor covered by a plurality of covering layers to adjust a radiation spectrum of excited light from the phosphor such that the photonic crystal phosphor 200 emits color light having a desired chromaticity.

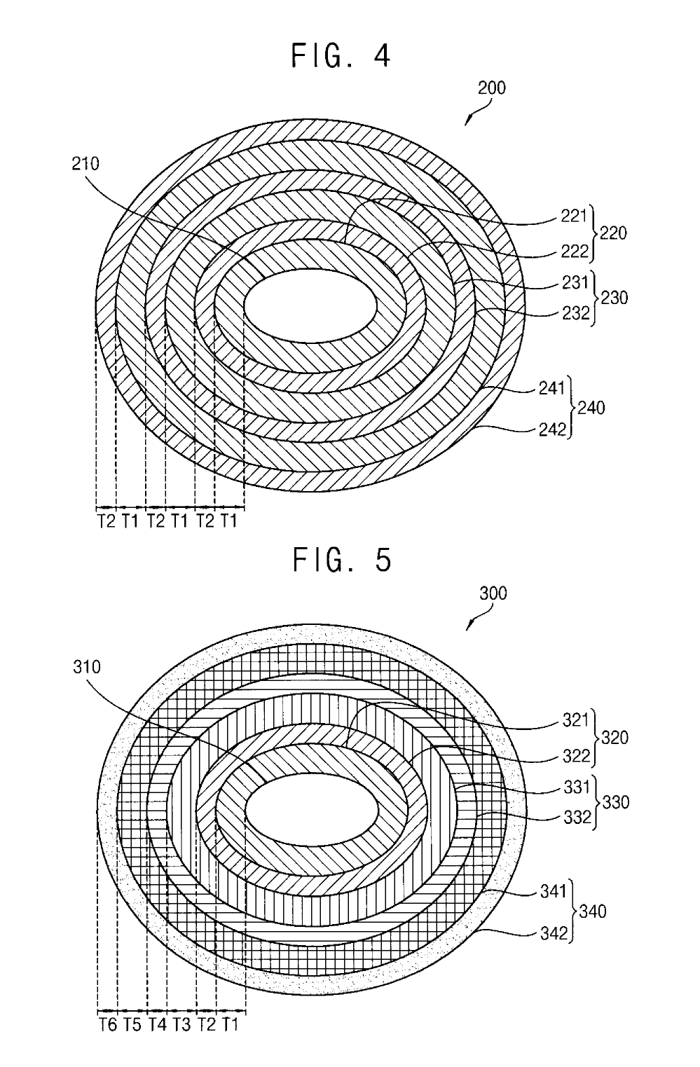

FIG. 5 is a cross-sectional view illustrating still another exemplary embodiment of a photonic crystal phosphor according to the invention.

Referring to FIG. 5, a photonic crystal phosphor 300 includes a phosphor 310 disposed substantially at a center of the photonic crystal phosphor 300, and a first covering layer 320 which covers an outer surface of the phosphor 310. The first covering layer 320 includes a first coating layer 321 covering the phosphor 310 and a second coating layer 322 covering the first coating layer 321.

Also, the exemplary embodiment of the photonic crystal phosphor 300 includes the phosphor 310 covered by a plurality of covering layers 320, 330 and 340. The covering layers 320, 330 and 340 have substantially different thicknesses and refractive indices from each other.

An outer surface of the first covering layer 320 is covered by a second covering layer 330 including a third coating layer 331 and a fourth coating layer 332. Likewise, an outer surface of the second covering layer 330 is covered by a third covering layer 340 including a fifth coating layer 341 and a sixth coating layer 342. Although the photonic crystal phosphor 300 includes three covering layers 320, 330 and 340 covering the phosphor 310 in FIG. 5, the number of the covering layers which cover the phosphor 310 may be various. In one exemplary embodiment, for example, the number of the covering layers may be equal to or more than 3 and equal to or less than 5, but is not limited thereto or thereby.

In the illustrated exemplary embodiment, first and second thicknesses and first and second refractive indices of the first covering layer 320, the second covering layer 330, and the third covering layer 340, respectively, may be substantially different from each other.

That is, first thicknesses of the first coating layer 321, the third coating layer 331 and the fifth coating layer 341 may be T1, T3 and T5, respectively, and may be different from each other, but not being limited thereto or thereby. First refractive indices of the first coating layer 321, the third coating layer 331 and the fifth coating layer 341 may be n₁, n₃ and n₅, respectively, and may be different from each other, but not being limited thereto or thereby. Two or more of the first coating layers 321, 331 and 341 may have first thicknesses and/or first refractive indices different from each other. Also, the first, the third and the fifth coating layers 321, 331 and 341 may include substantially different materials from each other. Two or more of the first coating layers 321, 331 and 341 may have materials different from each other.

Likewise, second thicknesses of the second coating layer 322, the fourth coating layer 332 and the sixth coating layer 342 may be T2, T4 and T6, respectively, and may be different from each other, but not being limited thereto or thereby. Second refractive indices of the second coating layer 322, the fourth coating layer 332 and the sixth coating layer 342 may be n₂, n₄ and n₆, respectively, and may be different from each other, but not being limited thereto or thereby. Two or more of the second coating layers 322, 332 and 342 may have second thicknesses and/or second refractive indices different from each other. Also, the second, the fourth and the sixth coating layers 322, 332 and 342 may include substantially different materials from each other. Two or more of the second coating layers 322, 332 and 342 may have materials different from each other.

As mentioned above, the exemplary embodiment of the photonic crystal phosphor 300 according to the invention includes a phosphor covered by a plurality of covering layers having substantially different thicknesses and refractive indices from each other to adjust a radiation spectrum of excited light from the phosphor such that the photonic crystal phosphor 300 emits color light having a desired chromaticity.

What is claimed is:

1. A photonic crystal phosphor comprising:
a phosphor which absorbs light and emits excited light having a radiation spectrum;
a first coating layer covering the phosphor, and having a first thickness and a first refractive index; and
a second coating layer covering the phosphor, and having a second thickness and a second refractive index,
wherein the first coating layer is between the phosphor and the second coating layer.

2. The photonic crystal phosphor of claim 1, wherein the first thickness is different from the second thickness.

3. The photonic crystal phosphor of claim 2, wherein the first thickness is determined by a maximum emission wavelength, a full width at half maximum of the radiation spectrum and the first refractive index.

4. The photonic crystal phosphor of claim 3, wherein the first thickness is substantially between (L−W_{H})/(4×n₁) and (L+W_{H})/(4×n₁) nanometers, and
wherein L represents the maximum emission wavelength, W_{H} represents the full width at half maximum and n₁ represents the first refractive index.

5. The photonic crystal phosphor of claim 2, wherein the second thickness is determined by a maximum emission wavelength, a full width at half maximum of the radiation spectrum and the second refractive index.

6. The photonic crystal phosphor of claim 5, wherein the second thickness is substantially between (L−W_{H})/(4×n₂) and (L+W_{H})/(4×n₂) nanometers, and
wherein L represents the maximum emission wavelength, W_{H} represents the full width at half maximum and n₂ represents the second refractive index.

7. The photonic crystal phosphor of claim 2, wherein the first thickness and the second thickness are determined by a maximum emission wavelength, a full width at half maximum of the radiation spectrum, the first refractive index and the second refractive index.

8. The photonic crystal phosphor of claim 7, wherein the first thickness is substantially between [L−100×|n₁−n₂|−W_{H}]/(4×n₁) and [L−100×|n₁−n₂|+W_{H}]/(4×n₁) nanometers, and
wherein L represents the maximum emission wavelength, W_{H} represents the full width at half maximum, n₁ represents the first refractive index and n₂ represents the second refractive index.

9. The photonic crystal phosphor of claim 7, wherein the second thickness is substantially between [L−100×|n₁−n₂|−W_{H}]/(4×n₂) and [L−100×|n₁−n₂|+W_{H}]/(4×n₂) nanometers, and
wherein L represents the maximum emission wavelength, W_{H} represents the full width at half maximum, n₁ represents the first refractive index and n₂ represents the second refractive index.

10. The photonic crystal phosphor of claim 7, wherein the first thickness is substantially between [L+100×|n₁−n₂|−W_{H}]/(4×n₁) and [L+100×|n₁−n₂|+W_{H}]/(4×n₁) nanometers, and
wherein L represents the maximum emission wavelength, W_{H} represents the full width at half maximum, n₁ represents the first refractive index and n₂ represents the second refractive index.

11. The photonic crystal phosphor of claim 7, wherein the second thickness is substantially between [L+100×|n₁−n₂|−W_{H}]/(4×n₂) and [L+100×|n₁−n₂|+W_{H}]/(4×n₂) nanometers, and
wherein L represents the maximum emission wavelength, W_{H} represents the full width at half maximum, n₁ represents the first refractive index and n₂ represents the second refractive index.

12. The photonic crystal phosphor of claim 1, wherein
a covering layer of the photonic crystal phosphor comprises the first coating layer and the second coating layer, and
the photonic crystal phosphor further comprises a plurality of covering layers which sequentially covers the phosphor.

13. The photonic crystal phosphor of claim 12, wherein a number of the covering layers which covers the phosphor is equal to or more than 3 and equal to or less than 5.

14. The photonic crystal phosphor of claim 1, wherein
a first covering layer of the photonic crystal phosphor comprises the first coating layer and the second coating layer,
the photonic crystal phosphor further comprises a second covering layer comprising:
a third coating layer covering the first covering layer, and having a third thickness and a third refractive index; and
a fourth coating layer covering the third coating layer, and having a fourth thickness and a fourth refractive index, and
the first covering layer is between the phosphor and the second covering layer.

15. The photonic crystal phosphor of claim 14, wherein the first and the second thicknesses are substantially different from the third and the fourth thicknesses, respectively.

16. The photonic crystal phosphor of claim 1, wherein the radiation spectrum has a maximum emission wavelength substantially between about 530 nanometers and about 550 nanometers.

17. The photonic crystal phosphor of claim 1, wherein the radiation spectrum has a maximum emission wavelength substantially between about 610 nanometers and about 670 nanometers.

18. The photonic crystal phosphor of claim 1, wherein the first and the second refractive indices are substantially between about 1.6 and about 2.5, respectively.

19. The photonic crystal phosphor of claim 1, wherein the first coating layer and the second coating layer comprises at least one of silicon oxide, titanium oxide, aluminum oxide, yttrium oxide, hafnium oxide, zinc oxide, zirconium oxide, magnesium oxide, gallium oxide, aluminum nitride and silicon carbide.
